(19) United States
(12) Patent Application Publication
(10) Pub. No.: US 2020/0271120 A1
(43) Pub. Date: Aug. 27, 2020

(54) VACUUM PUMP AND CONTROL METHOD THEREFOR

(71) Applicant: ULVAC, INC., Chigasaki-shi, Kanagawa (JP)

(72) Inventors: Yasuhiro KIMURA, Chigasaki-shi, Kanagawa (JP); Kenji MACHIYA, Chigasaki-shi, Kanagawa (JP); Shinnosuke TOKUHIRA, Chigasaki-shi, Kanagawa (JP); Hideaki INOUE, Chigasaki-shi, Kanagawa (JP)

(21) Appl. No.: 16/652,355

(22) PCT Filed: Jun. 20, 2018
(86) PCT No.: PCT/JP2018/023490

§ 371 Date: Mar. 30, 2020

(30) Foreign Application Priority Data
Oct. 31, 2017 (JP) 2017-210448

(51) Int. Cl. F04D 27/00; H02P 29/66; H02P 29/68; F04D 25/06

(52) U.S. Cl. CPC F04D 27/001; H02P 29/662; H02P 2207/055; F04D 25/06; H02P 29/68

(57) ABSTRACT

A vacuum pump according to an embodiment of the present invention includes a pump main body, a first temperature sensor, a motor, and a control unit. The pump main body includes a rotary shaft and a metal casing portion. The first temperature sensor is attached to the casing portion and detects a temperature of the casing portion. The motor includes a rotor core including a permanent magnet and attached to the rotary shaft, a stator core including a plurality of coils, and a can that houses the rotor core. The control unit includes a driving circuit and a correcting circuit. The driving circuit supplies the plurality of coils with a driving signal for rotating the motor on a basis of a pre-set induced voltage constant. The correcting circuit corrects the induced voltage constant on a basis of an output of the first temperature sensor.

### TECHNICAL FIELD

The present invention relates to a vacuum pump including a permanent magnet synchronous motor and a control method therefor.

### BACKGROUND ART

A mechanical booster pump is a positive displacement vacuum pump that rotates two cocoon-shaped pump rotors, which are arranged in a pump chamber inside a casing, in synchronization with each other in opposite directions and transports gas from an intake port to a discharge port. In the mechanical booster pump, there are no contacts between both the pump rotors and between each pump rotor and the casing. Therefore, it has an advantage that the mechanical loss is extremely low and energy required for driving can be reduced in comparison with a vacuum pump having large frictional work like an oil-rotary vacuum pump, for example.

The mechanical booster pump typically constitutes a vacuum pumping system together with an auxiliary pump and is used for starting an operation and amplifying the pumping speed after lowering the pressure to a certain level by the use of the auxiliary pump.

In the vacuum pump of this type, the canned motor is widely used as a driving source that rotates each pump rotor. The canned motor has a cylindrical can inserted into a clearance between a rotor core and a stator core. The rotor core is hermetically sealed by the can, and thus gas entering the rotor core through a bearing portion is prevented from leaking toward the atmosphere (outside air). For example, Patent Literature 1 has disclosed a permanent magnet synchronous canned motor.

On the other hand, in the permanent magnet synchronous motor, a permanent magnet fixed to the rotor core has a temperature characteristic. Therefore, a change in magnetic flux amount of the permanent magnet along with a temperature change may greatly influence motor control and pump performance. For example, if a high load makes the motor temperature high, the motor steps out due to a decrease in magnetic flux amount of the permanent magnet and desired pump performance cannot be obtained.

Moreover, even assuming a magnetic flux exerted at a temperature stabilized with rated power, the pump performance cannot be maintained until a stable temperature is provided after the start.

In order to solve such a problem, for example, Patent Literature 2 has proposed a pump device that detects a temperature inside an inverter by the use of a temperature detector attached to a housing portion of a permanent magnet motor, estimates a temperature of the permanent magnet on the basis of the temperature detected by the temperature detector, and corrects a control constant for controlling the motor on the basis of the estimated temperature.

### CITATION LIST

### Patent Literature

Patent Literature 1: Japanese Patent Application Laid-open No. 2008-295222
Patent Literature 2: Japanese Patent Application Laid-open No. 2016-111793

### DISCLOSURE OF INVENTION

### Technical Problem

In the pump device described in Patent Literature 2, the temperature of the permanent magnet is estimated on the basis of the temperature of the housing portion of the motor. However, the temperature characteristic of the housing portion is different from the temperature characteristic of the permanent magnet of the rotor core, and thus it is difficult to realize suitable r.p.m. control of the motor.

In view of the above-mentioned circumstances, it is an object of the present invention to provide a vacuum pump and a control method therefor, by which the pump performance can be stably maintained even if thermal fluctuation occurs.

### Solution to Problem

In order to accomplish the above-mentioned object, a vacuum pump according to an embodiment of the present invention includes a pump main body, a first temperature sensor, a motor, and a control unit.

The pump main body includes a rotary shaft and a metal casing portion.

The first temperature sensor is attached to the casing portion and detects a temperature of the casing portion.

The motor includes a rotor core including a permanent magnet and attached to the rotary shaft, a stator core including a plurality of coils, and a can that houses the rotor core.

The control unit includes a driving circuit and a correcting circuit. The driving circuit supplies the plurality of coils with a driving signal for rotating the motor on a basis of a pre-set induced voltage constant. The correcting circuit corrects the induced voltage constant on a basis of an output of the first temperature sensor.

In accordance with the vacuum pump, the first temperature sensor is configured to detect the temperature of the casing portion of the pump main body configured to have a thermal time constant similar to that of the permanent magnet of the rotor core. Thus, the estimation accuracy of the temperature of the permanent magnet is increased. With this, even if thermal fluctuation occurs, the induced voltage constant can be optimized, and thus the pump performance can be stably maintained.

The correcting circuit is typically configured to correct the induced voltage constant such that an induced voltage of the motor becomes lower as the temperature of the casing portion becomes higher if the temperature of the casing portion is within a predetermined temperature range.

With this, a high-load continuous operation of the vacuum pump can be realized by preventing the motor to step out due to a decrease in magnetic flux amount of the permanent magnet along with an increase in motor temperature.

The correcting circuit may be configured to correct the induced voltage constant in accordance with a first approximate straight line having a first temperature gradient if the temperature of the casing portion is equal to or higher than a first temperature and is lower than a second temperature, and correct the induced voltage constant in accordance with a second approximate straight line having a second temperature gradient different from the first temperature gradient if the temperature of the casing portion is equal to or higher than the second temperature and is lower than a third temperature.

The control unit may further include a second temperature sensor that detects a temperature of the driving circuit. The driving circuit stops supply of the driving signal into the plurality of coils if the temperature of the driving circuit is equal to or higher than the third temperature.

The second temperature sensor that detects the temperature of the driving circuit is provided separately from the first temperature sensor, and thus the temperature of the driving circuit can be suitably detected.

A control method for a vacuum pump including a permanent magnet synchronous motor according to an embodiment of the present invention includes generating a driving signal for rotating the motor on a basis of a pre-set induced voltage constant.

The induced voltage constant is corrected on a basis of an output of a temperature sensor attached to a metal casing portion that constitutes a part of a pump main body.

### Advantageous Effects of Invention

As described above, in accordance with the present invention, the pump performance can be stably maintained even if thermal fluctuation occurs.

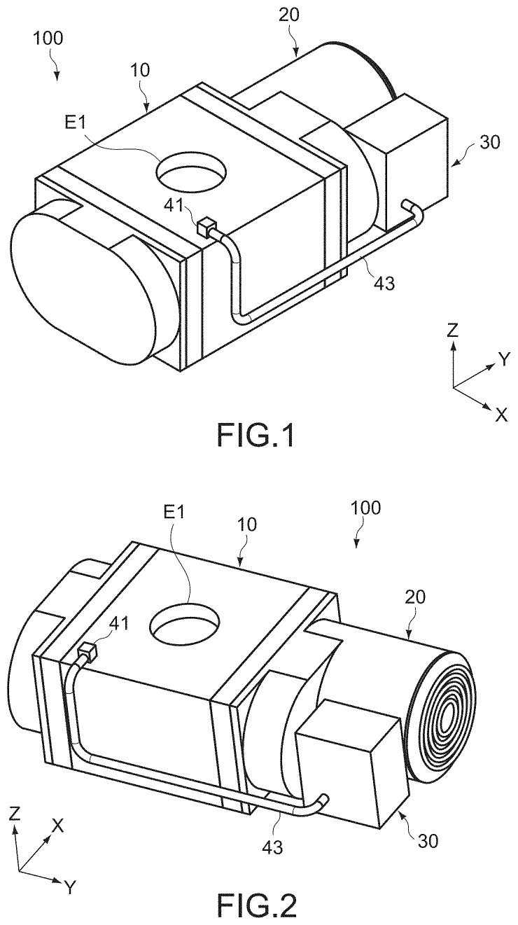

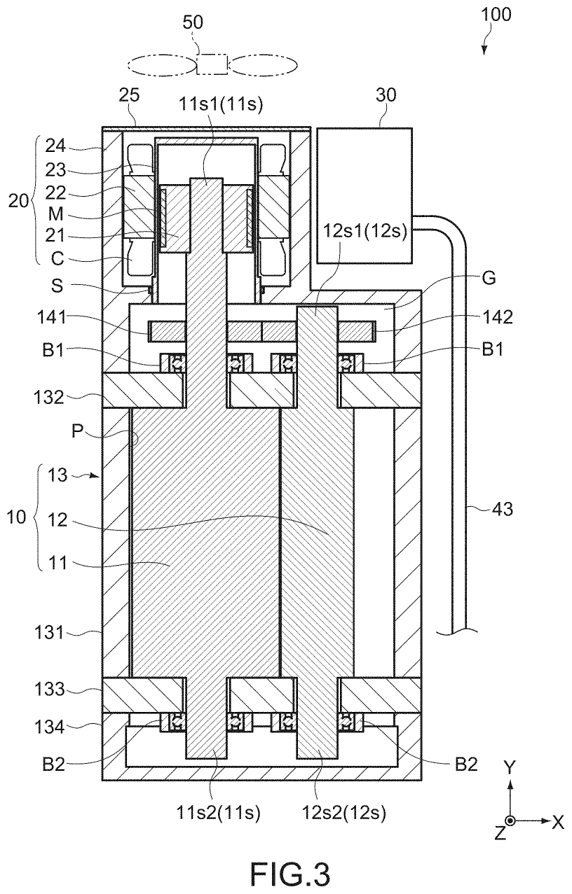

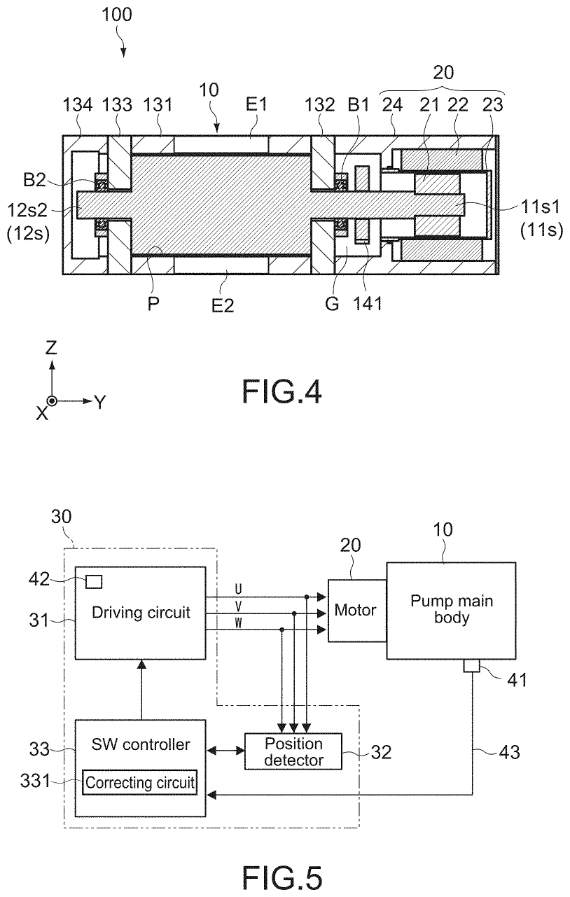

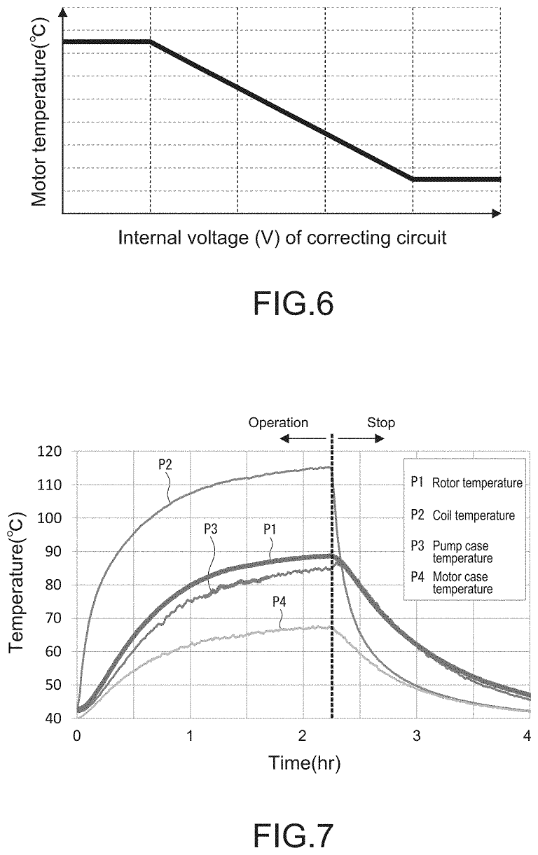

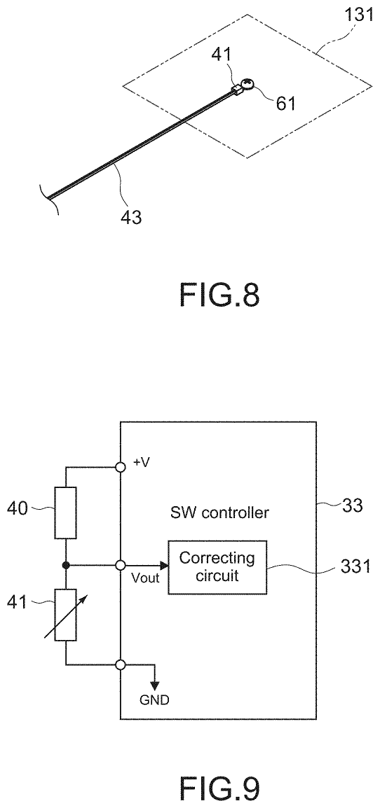

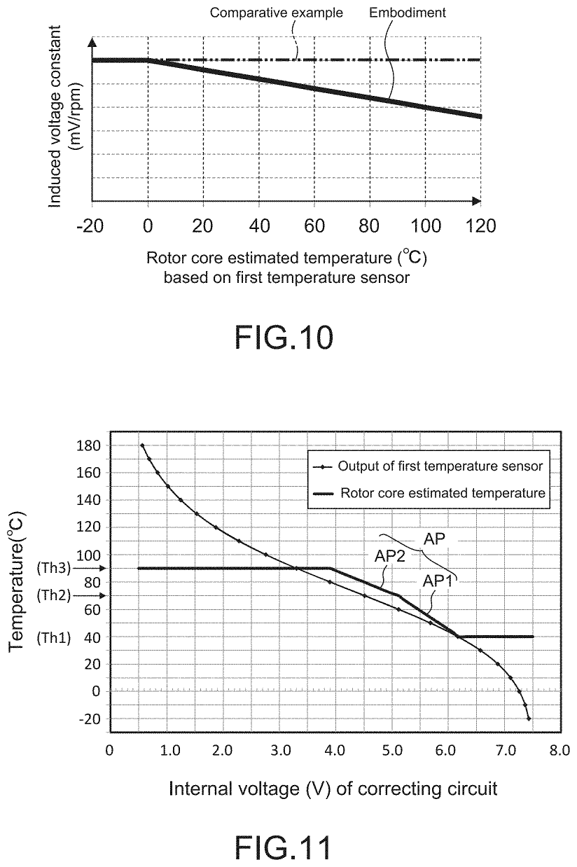

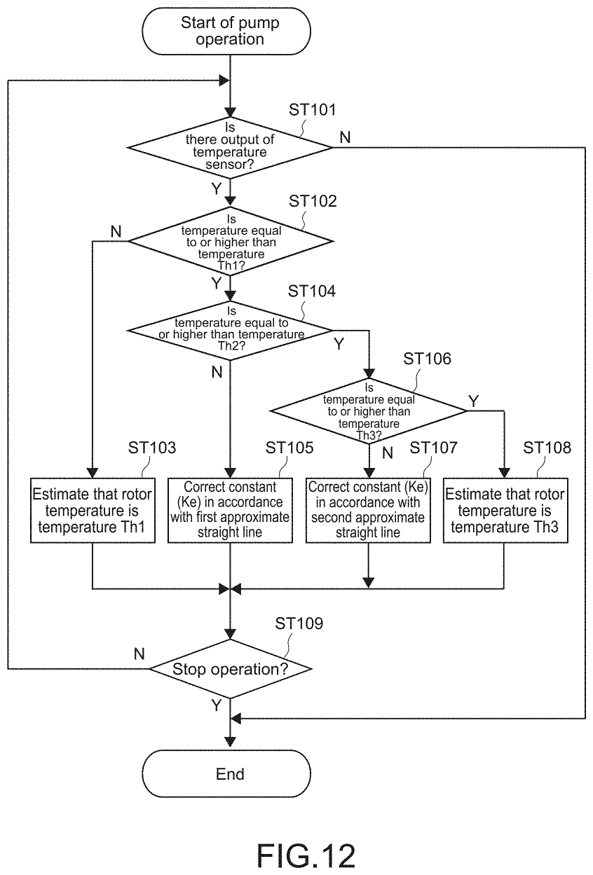

### BRIEF DESCRIPTION OF DRAWINGS

[FIG. 1] An entire perspective view as viewed from one side of a vacuum pump according to an embodiment of the present invention.

[FIG. 2] An entire perspective view as viewed from the other side of the vacuum pump.

[FIG. 3] A schematic enlarged cross-sectional view showing an internal structure of the vacuum pump.

[FIG. 4] A schematic sectional side view showing the internal structure of the vacuum pump.

[FIG. 5] A block diagram schematically showing a configuration of a control unit in the vacuum pump.

[FIG. 6] A diagram showing a control example of an internal voltage of a correcting circuit by the control unit.

[FIG. 7] An experimental result showing a temperature change in respective parts of the vacuum pump when it is operated under a predetermined condition.

[FIG. 8] A perspective view describing an attachment example of a first temperature sensor in the vacuum pump.

[FIG. 9] An equivalent circuit diagram describing a temperature detection method using the first temperature sensor.

[FIG. 10] A conceptual diagram describing an action of the correcting circuit in the control unit.

[FIG. 11] A diagram showing a relationship between a rotor core estimated temperature of a motor, which is based on the first temperature sensor, and an input voltage.

[FIG. 12] A flowchart showing an example of a processing procedure executed by the control unit.

### MODE(S) FOR CARRYING OUT THE INVENTION

Hereinafter, an embodiment of the present invention will be described with reference to the drawings.

[Overall Configuration]

FIG. 1 is an entire perspective view as viewed from one side of a vacuum pump according to an embodiment of the present invention. FIG. 2 is an entire perspective view as viewed from the other side of the vacuum pump. FIG. 3 is a schematic enlarged cross-sectional view showing an internal structure of the vacuum pump. FIG. 4 is a schematic sectional side view showing the internal structure of the vacuum pump.

In the figure, an X-axis, a Y-axis, and a Z-axis show three axis directions orthogonal to one another.

A vacuum pump 100 according to this embodiment includes a pump main body 10, a motor 20, and a control unit 30. The vacuum pump 100 is constituted by a single-stage mechanical booster pump.

(Pump Main Body)

The pump main body 10 includes a first pump rotor 11, a second pump rotor 12, and a casing 13 that houses the first and second pump rotors 11 and 12.

The casing 13 includes a first casing portion 131, partition walls 132 and 133 arranged at both ends of the first casing portion 131 in a Y-axis direction, and a second casing portion 134 fixed to the partition wall 133. The first casing portion 131 and the partition walls 132 and 133 form a pump chamber P that houses the first and second pump rotors 11 and 12.

The first casing portion 131 and the partition walls 132 and 133 are constituted by an iron-based metal material such as cast iron and stainless steel, for example, and are coupled to each other via a seal ring (not shown). The second casing portion 134 is constituted by a non-iron-based metal material such as an aluminum alloy, for example.

An intake port E1 communicating with the pump chamber P is formed in one main surface of the first casing portion 131. A discharge port E2 communicating with the pump chamber P is formed in the other main surface. An intake pipe communicating with an inside of a vacuum chamber (not shown) is connected to the intake port E1. An intake port of a discharge pipe or an auxiliary pump (not shown) is connected to the discharge port E2.

The first and second pump rotors 11 and 12 are constituted by cocoon-shaped rotors made of an iron-based material such as cast iron and are arranged to be opposite to each other in an X-axis direction. The first and second pump rotors 11 and 12 respectively include rotary shafts 11s and 12s parallel in the Y-axis direction. A bearing B1 fixed to the partition wall 132 is rotatably supported on sides of one end portions 11s1 and 12s1 of the respective rotary shafts 11s and 12s. A bearing B2 fixed to the partition wall 133 is rotatably supported on sides of the other end portion 101s2 and 12s2 of the respective rotary shafts 11s and 12s. A predetermined clearance is formed between the first pump rotor 11 and the second pump rotor 12 and between the respective pump rotors 11 and 12 and an inner wall surface of the pump chamber P. The respective pump rotors 11 and 12 are configured to rotate mutually and in a contactless manner with the inner wall surface of the pump chamber P.

A rotor core 21 constituting the motor 20 is fixed to the one end portion 11s1 of the rotary shaft 11s of the first pump rotor 11. A first synchronous gear 141 is fixed between the rotor core 21 and the bearing B1. A second synchronous gear 142 that meshes with the first synchronous gear 141 is fixed to the one end portion 12s1 of the rotary shaft 12s of the second pump rotor 12. By driving of the motor 20, the first and second pump rotors 11 and 12 rotate mutually in opposite directions via the synchronous gears 141 and 142. With this, gas is transported from the intake port E1 to the discharge port E2.

(Motor)

The motor 20 is constituted by a permanent magnet synchronous canned motor. The motor 20 includes the rotor core 21, a stator core 22, a can 23, and a motor case 24.

The rotor core 21 is fixed to the one end portion 11s1 of the rotary shaft 11s of the first pump rotor 11. The rotor core 21 includes a laminate of electrical steel plates and a plurality of permanent magnets M attached to a peripheral surface thereof. The permanent magnets M are arranged having alternately different polarities (N pole and S pole) along the periphery of the rotor core 21.

In this embodiment, an iron-based material such as a neodymium magnet and a ferrite magnet is used as the permanent magnet material. The arrangement form of the permanent magnets is not particularly limited. A surface permanent magnet (SPM) type in which the permanent magnets are arranged on the surface of the rotor core 21 may be employed. Alternatively, an interior permanent magnet (IPM) type in which the permanent magnets are embedded in the rotor core 21 may be employed.

The stator core 22 is arranged in the periphery of the rotor core 21 and is fixed to the inner wall surface of the motor case 24. The stator core 22 includes a laminate of electrical steel plates and a plurality of coils C wound around it. The coils C are constituted by a three-phase winding including a U-phase winding, a V-phase winding, and a W-phase winding. The coils C are each electrically connected to a control unit 30.

The can 23 is arranged between the rotor core 21 and the stator core 22 and houses the rotor core 21 therein. The can 23 is a circular tubular member having a bottom and including one open end on a side of a gear chamber G, which is constituted by a synthetic resin material such as polyphenylenesulfide (PPS) and polyetheretherketone (PEEK). The can 23 is fixed to the motor case 24 via a seal ring S attached to the periphery on an open end portion side thereof and seals the rotor core 21 from the atmosphere (outside air).

The motor case 24 is constituted by an aluminum alloy, for example. The motor case 24 houses the rotor core 21, the stator core 22, the can 23, and the synchronous gears 141 and 142. The motor case 24 forms the gear chamber G by being fixed to the partition wall 132 via a seal ring (not shown). The gear chamber G houses lubricating oil for lubricating the synchronous gears 141 and 142 and the bearing B1. Typically, a plurality of heat dissipation fins are provided in an outer surface of the motor case 24.

A tip end of the motor case 24 is covered with a cover 25. The cover 25 is provided with a through-hole communicable with the outside air. The cover 25 is configured to be capable of cooling the rotor core 21 and the stator core 22 via a cooling fan 50 arranged next to the motor 20. Instead of or in addition to the cooling fan 50, a structure capable of water-cooling the motor case 24 may be employed.

(Control Unit)

FIG. 5 is a block diagram schematically showing a configuration of the control unit 30.

As shown in FIG. 5, the control unit 30 includes a driving circuit 31, a position detector 32, and a switching (SW) controller 33. The control unit 30 is for controlling driving of the motor 20. The control unit 30 is constituted by a circuit board housed in a case made of metal, for example, which is mounted on the motor case 24, and various electronic components mounted thereon.

The driving circuit 31 generates a driving signal for rotating the motor 20 at predetermined r.p.m. A plurality of semiconductor switching elements (transistors) are constituted by an inverter circuit. Those semiconductor switching elements each generate a driving signal to be supplied to the coils C (U-phase winding, V-phase winding, and W-phase winding) of the stator core 22 in such a manner that the SW controller 33 individually controls an open/close timing.

The driving circuit 31 includes a temperature sensor 42 (second temperature sensor). The temperature sensor 42 detects the temperature of the driving circuit 31. If it is equal to or higher than a predetermined temperature (e.g., 90° C.), the driving circuit 31 stops supplying the driving signal into the coils C. With this, the motor 20 can be put in a free-run state and the temperature of the motor 20 can be prevented from further increasing.

The position detector 32 is electrically connected to the coils C of the stator 22. The position detector 32 indirectly detects a magnetic pole position of the rotor core 21 on the basis of a waveform of opposite electromotive force generated in the coils C due to a change over time in magnetic flux (interlinkage magnetic flux) crossing the coils C. Then, the position detector 32 outputs it to the SW controller 33 as a position detection signal for controlling a timing at which the coils C are supplied with electricity.

The SW controller 33 outputs control signals for exciting the coils C (three-phase winding) of the stator core 22 to the driving circuit 31 on the basis of an induced voltage constant (Ke) and the magnetic pole position of the rotor core 21, which is detected by the position detector 32. That is, the SW controller 33 is configured to detect the magnetic pole position of the rotor core, which is acquired by the position detector 32, and load torque of the motor 20, generate a control signal for rotating the motor 20 on the basis of that load torque without stepping out the motor 20, and output it to the driving circuit 31. The induced voltage constant is a control parameter for controlling the induced voltage of the motor. Typically, an arbitrary value determined in a manner that depends on the strength of the magnetic flux of the rotor core 21 (permanent magnets M), the specifications of the vacuum pump, operation condition, or the like is preset in the SW controller 33.

Here, when a high-load operation is continuously performed, the pump main body 10 generates heat by mechanical work and the like and the motor 20 also generates heat due to eddy current loss and the like. When the temperature of the rotor core 21 increases, a magnetic flux amount of the permanent magnets M decreases (demagnetization) and the motor 20 easily steps out. When the motor 20 steps out, desired pump performance cannot be obtained. It is thus desirable to provide a technology by which the pump performance can be maintained without causing the motor 20 to step out during heat generation of the motor 20.

The vacuum pump 100 of this embodiment is configured to estimate a temperature of the rotor core 21 (permanent magnets M) and correct the induced voltage constant on the basis of the estimated temperature. That is, in order to prevent the induced voltage constant set in the inverter (driving circuit 31) from becoming inappropriate for the magnetic flux amount of the permanent magnets M of the rotor core due to a change in motor temperature, the motor 20 is prevented from stepping out by correcting the induced voltage constant of the inverter in a manner that depends on a change in magnetic flux amount of the motor.

Here, the induced voltage of the motor 20 is controlled in accordance with an input voltage from the driving circuit 31 to the coils C. The input voltage is determined in accordance with an internal voltage (Vout) (see FIG. 9) of a correcting circuit 331 to be described later. The internal voltage of the correcting circuit 331 is typically set to become lower as the motor temperature becomes higher as shown in FIG. 6. The value of the internal voltage of the correcting circuit is determined in accordance with the induced voltage constant.

The vacuum pump 100 of this embodiment is configured to estimate a temperature of the rotor core 21 on the basis of a temperature of the first casing portion 131 of the pump main body 10 and correct the induced voltage constant on the basis of the estimated value. The first casing portion 131 is constituted by a metal material, and thus the first casing portion 131 has a thermal time constant similar to that of the permanent magnets of the rotor core. With this, the temperature estimation accuracy of the rotor core 21 and the permanent magnets M increases and suitable driving control of the motor at the time of the high-load operation can be realized.

FIG. 7 is an experimental result showing a temperature change in respective parts of the vacuum pump 100 when the operation is stopped and the atmosphere is released (cooled) after exhaustion (load operation) is continuously performed for two or more hours at an outside-air temperature of 40° C. In the figure, a rotor temperature P1 indicates the temperature of the rotor core 21, a coil temperature P2 indicates the temperature of the coils C, a pump case temperature P3 indicates the temperature of the first casing portion 131, and a motor case temperature P4 indicates a surface temperature of the motor case 24.

It should be noted that an output of a radiation thermometer set on the tip end of the motor case 24 was referred to for measurement of P1 (the measurement region was painted in black and the emissivity was adjusted in order to reduce influences due to an emissivity difference of measurement regions). An output of a temperature measurement element such as a thermistor set at each site was referred to for measurement of P2 to P4.

As shown in FIG. 7, the pump case temperature P3 corresponds to the temperature of the first casing portion 131 constituted by the same Fe-based material as the rotor core 21 (permanent magnets M) and has a temperature characteristic substantially similar to that of the rotor temperature P1 as compared to the coil temperature P2 and the motor case temperature P4. An estimated cause is that the first casing portion 131 faces the pump chamber P which is one of temperature increasing sources during operation and has such a heat capacity that the radiational cooling characteristic thereof is equivalent to that of the rotor core 21. Therefore, a temperature of the rotor core 21 can be estimated at a relatively high accuracy by referring to the pump case temperature P3.

In view of this, the vacuum pump 100 of this embodiment includes a temperature sensor 41 (first temperature sensor) that detects the temperature of the first casing portion 131. A thermistor is employed as the temperature sensor 41, though not limited thereto. Another temperature measurement element such as a thermocouple may be employed. An output of the temperature sensor 41 is input into the SW controller 33 via a wire cable 43.

A method of attaching the temperature sensor 41 is not particularly limited. For example, as shown in FIG. 8, the temperature sensor 41 is fixed to an outer surface of the first casing portion 131 with a suitable fixture 61 such as a screw. A site of the first casing portion 131, at which the temperature sensor 41 is attached, is also not particularly limited. That site may be one end side (side of the partition wall 132) of the first casing portion 131, may be the other end side (side of the partition wall 133), or may be an intermediate part therebetween.

The SW controller 33 includes the correcting circuit 331 that corrects the induced voltage constant which is a control parameter of the motor 20 on the basis of the output of the temperature sensor 41. In this embodiment, the correcting circuit 331 is configured as a part of the SW controller 33. Alternatively, the correcting circuit 331 may be configured as a circuit different from the SW controller 33.

FIG. 9 is an equivalent circuit showing a relationship between the SW controller 33, the correcting circuit 331, and the temperature sensor 41. The temperature sensor 41 is connected to the SW controller 33 via a voltage dividing resistance 40. An output (Vout) of a voltage dividing circuit constituted by the temperature sensor 41 and the voltage dividing resistance 40 is input into the correcting circuit 331. The output (Vout) of the voltage dividing circuit corresponds to the internal voltage of the correcting circuit 331.

The correcting circuit 331 is configured to correct the induced voltage constant such that the induced voltage of the motor 20 becomes lower as the temperature of the first casing portion 131 becomes higher if the temperature of the first casing portion 131 is within a predetermined temperature range. With this, a high-load continuous operation of the vacuum pump 100 can be realized by preventing the motor 20 to step out due to a decrease in magnetic flux amount of the permanent magnets M along with thermal modulation of the motor 20, for example, an increase in motor temperature.

For example, FIG. 10 is a conceptual diagram showing an example of correction of the induced voltage constant by the correcting circuit 331, which shows a relationship between a temperature of the rotor core 21, which is estimated on the basis of the output of the temperature sensor 41, and the induced voltage constant. The correcting circuit 331 makes the induced voltage constant smaller as the estimated temperature of the rotor core 21 becomes higher. That is, unlike a comparative example in which the motor 20 is driven at a fixed induced voltage constant irrespective of the motor temperature, the motor 20 is driven at the induced voltage constant corresponding to the amount of decrease in magnetic force of the permanent magnets M along with the increase in temperature. With this, it becomes possible to stably drive the vacuum pump 100 without causing the motor 20 to step out.

Moreover, in the example of FIG. 10, the induced voltage constant linearly changes relative to the estimated temperature of the rotor core 21 within a temperature range of 0° C. or more. A tilt of the induced voltage constant in this case is set to correspond to a temperature coefficient of the permanent magnets M. In a case where the temperature coefficient of the permanent magnets M is non-linear, the gradient of the induced voltage constant can be also non-linear. A lower limit of the temperature at which the induced voltage constant is to be corrected is not limited to 0° C. and may be higher or lower than 0° C.

A method of estimating a temperature of the rotor core 21, which is based on the output of the temperature sensor 41, will be described.

FIG. 11 shows a temperature characteristic of the output of the temperature sensor 41. A thermistor which is a semiconductor component is used as the temperature sensor 41 and has a non-linear temperature characteristic different from that of the rotor core 21 (permanent magnets M). In view of this, the correcting circuit 331 sets, on the basis of the output of the temperature sensor 41, an approximate straight line AP for estimating a temperature of the rotor core 21 (permanent magnets M) as shown as the thick solid line of the figure within a temperature range of 40° C. to 90° C. and acquires a temperature corresponding to the approximate straight line AP as the estimated temperature of the rotor core 21. The correcting circuit 331 corrects the induced voltage constant on the basis of the acquired estimated temperature (FIG. 10).

For example, in a case where a temperature detected by the temperature sensor 41 is 70° C., the internal voltage of the correcting circuit 331 is 4.5 V (FIG. 11). The correcting circuit 331 acquires the estimated temperature of the rotor core 21 corresponding to that internal voltage value on the basis of the approximate straight line AP (in this example, 80° C.), and corrects the induced voltage constant to a value corresponding to the estimated temperature (see FIG. 10).

Moreover, if the temperature of the first casing portion 131, which is detected by the temperature sensor 41, is equal to or higher than a first temperature Th1 (40° C.) and is lower than a second temperature Th2 (70° C.) as shown in FIG. 11, the correcting circuit 331 of this embodiment corrects the induced voltage constant in accordance with a first approximate straight line AP1 having a first temperature gradient.

On the other hand, if the temperature of the first casing portion 131, which is detected by the temperature sensor 41, is equal to or higher than the second temperature Th2 and is lower than a third temperature Th3 (90° C.), the correcting circuit 331 corrects the induced voltage constant in accordance with a second approximate straight line AP2 having a second temperature gradient different from the first temperature gradient.

Those first and second gradients are set as appropriate in accordance with the temperature characteristic of the output of the temperature sensor 41, which is 40° C. or more and 90° C. or less. In this embodiment, the first temperature gradient is set to be larger than the second gradient such that the estimated temperature of the rotor core 21 within that temperature range is higher than the temperature detected by the temperature sensor 41 by about 10° C. for example. By estimating the rotor core estimated temperature a little higher in this manner, the motor 20 within that temperature range can be reliably prevented from stepping out.

The first to third temperatures Th1 to Th3 are examples and can be changed as appropriate in accordance with the kinds and specifications of the motor. The first and second approximate straight lines AP1 and AP2 can also be set as appropriate in accordance with the temperature characteristic of the temperature sensor 41. The approximate straight lines are not limited to two and one or three or more approximate straight lines may be set. The approximation is not limited to the straight one and may be a curve. Moreover, the approximation does not need to be continuous and may be discrete.

If the temperature of the first casing portion 131 is lower than the first temperature Th10 (40° C.), the correcting circuit 331 estimates that the temperature of the rotor core 21 (permanent magnets M) is the first temperature Th1. On the other hand, if the temperature of the first casing portion 131 is equal to or higher than the third temperature Th3 (90° C.), the correcting circuit 331 estimates that the temperature of the rotor core 21 (permanent magnets M) is the third temperature Th3. If the temperature of the driving circuit 31 is 90° C. or more, the driving circuit 31 stops generating a driving signal on the basis of the output of the temperature sensor 42 (see FIG. 5) as described above.

When detecting disconnection of the wire cable 43 of the temperature sensor 41, the correcting circuit 331 is configured to stop the motor 20 such that driving of the vacuum pump 20 stops or controls the driving circuit 31 so as to put it in a free-run state. The disconnection of the wire cable 43 can be detected on the basis of the output (Vout) of the voltage dividing circuit (see FIG. 9).

[Operation of Vacuum Pump]

Next, a typical operation of the vacuum pump 100 of this embodiment, which is configured as described above, will be described.

FIG. 12 is a flowchart showing an example of a processing procedure executed by the control unit 30.

When the operation of the vacuum pump 100 is started, the control unit 30 generates a driving signal for rotating the motor 20 at predetermined r.p.m. on the basis of the induced voltage constant (Ke) pre-set (before correction). The first and second pump rotors 11 and 12 rotate by activation of the motor 20. A predetermined pump action of discharging gas inside the vacuum chamber (not shown), which is taken in through the intake port E1, through the discharge port E2 is performed.

When the high-load operation is continuously performed, the pump main body 10 generates heat by mechanical work and the like and the motor 20 also generates heat due to eddy current loss and the like. When the temperature of the rotor core 21 increases, the magnetic flux amount of the permanent magnets M decreases (demagnetization) and the motor 20 easily steps out. When the motor 20 steps out, desired pump performance cannot be obtained.

In view of this, the control unit 30 (correcting circuit 331) corrects the induced voltage constant for controlling the induced voltage of the motor 20 on the basis of the output of the temperature sensor 41 attached to the iron-based casing portion (first casing portion 131) constituting a part of the pump main body 10.

More specifically, as shown in FIG. 12, the correcting circuit 331 acquires a temperature of the first casing portion 131 on the basis of the output of the temperature sensor 41 (first temperature sensor) (Step 101). Then, the correcting circuit 331 determines whether or not the temperature of the first casing portion 131 is equal to or higher than the first temperature Th1 (40° C.), estimates that the temperature of the rotor core 21 (permanent magnets M) is the first temperature Th1 if it is lower than the first temperature Th1, and continues driving the motor 20 without changing the control constant (Steps 102 and 103).

On the other hand, if the temperature of the first casing portion 131 is equal to or higher than the first temperature Th1 and the second temperature Th2 (70° C.), the correcting circuit 331 corrects the induced voltage constant to lower the induced voltage in accordance with the first approximate straight line AP1 (FIGS. 6, 10, and 11 and Steps 104 and 105).

If the temperature of the first casing portion 131 is equal to or higher than the second temperature Th2 and is lower than the third temperature Th3 (90° C.), the correcting circuit 331 corrects the induced voltage constant to lower the induced voltage in accordance with the second approximate straight line AP2 (see FIG. 11) (FIGS. 6, 10, and 11 and Steps 106 and 107).

As described above, the induced voltage constant is corrected to lower the induced voltage of the motor 20 as the temperature of the first casing portion 131 becomes higher. Therefore, it becomes possible to stably drive the vacuum pump 100 without causing the motor 20 to step out. The r.p.m. is typically maintained constant with no changes before and after correction of the induced voltage of the motor 20. Therefore, the pump performance is stably maintained.

In the mechanical booster pump, a torque limiter that protects the pump by lowering the r.p.m. is often used at much higher load (near the pressure of the atmosphere). In that case, the work of the pump decreases and the motor rotor temperature and the pump main body temperature decrease. By increasing the induced voltage constant following it, stable control is realized also in the case of using the torque limiter.

In the case where the temperature of the first casing portion 131 is equal to or higher than the third temperature Th3, the control unit 30 estimates that the temperature of the rotor core 21 (permanent magnets M) is the third temperature and continues driving the motor 20 at the induced voltage constant corresponding to the third temperature. When the temperature of the motor 20 further increases, generation of a driving signal by the driving circuit 31 is stopped on the basis of the output of the temperature sensor 42 inside the driving circuit 31 and the motor 20 is put in a free-run state. Also when an output cannot be obtained from the temperature sensor 41 due to disconnection and the like of the wire cable 43, the motor 20 is similarly put in a free-run state.

The above-mentioned operation is repeatedly executed until an operation to stop the operation of the vacuum pump 100 is performed (Step 109).

In accordance with this embodiment, the temperature sensor 41 is configured to detect the temperature of the first casing portion 131 constituted by a material having a thermal time constant similar to that of the permanent magnets M of the rotor core 21, and thus the temperature estimation accuracy of the permanent magnets M can be increased. With this, suitable driving control of the motor at the time of the high-load operation can be realized. Then, the pump performance in a high load (high pressure) region can be stably maintained, and thus the pumping time can be shortened and the productivity of vacuum treatment can be enhanced.

In accordance with this embodiment, the induced voltage constant of the motor 20 is corrected in accordance with the temperature of the rotor core 21 (permanent magnets M). Therefore, the motor 20 can be driven without causing the motor 20 to step out without the need for a cooling structure having a relatively large capacity for cooling the motor 20. Such an effect can greatly contribute to a reduction in equipment cost of the vacuum pump including the permanent magnet synchronous canned motor.

Moreover, in accordance with this embodiment, the temperature sensor 42 that detects the temperature of the driving circuit 31 is provided separately from the temperature sensor 41 for estimating a temperature of the rotor core 21. Therefore, the temperature of the driving circuit 31 can be suitably detected and the driving circuit 31 can be protected.

Although the embodiment of the present invention has been described above, the present invention is not limited only to the above-mentioned embodiment and various modifications can be made as a matter of course.

For example, in the above-mentioned embodiment, the mechanical booster pump has been described as an example of the vacuum pump, though not limited thereto. The present invention is applicable to another positive displacement vacuum pump such as a screw pump and a multi-stage roots pump.

Further, in the above-mentioned embodiment, the temperature sensor 41 is configured to detect the temperature of the first casing portion 131 of the pump main body 10, though not limited thereto. The temperature sensor 41 may be configured to detect the temperature of the partition walls 132 and 133 or the second casing portion 134.

### REFERENCE SIGNS LIST

10 pump main body
11s, 12s rotary shaft
20 motor
21 rotor core
22 stator core
23 can
24 motor case
30 control unit
31 driving circuit
32 position detector
33 SW controller
41 first temperature sensor
42 second temperature sensor
100 vacuum pump
131 first casing portion
331 correcting circuit
M permanent magnet

1. A vacuum pump, comprising:
a pump main body including
a rotary shaft, and
a metal casing portion,
a first temperature sensor that is attached to the casing portion and detects a temperature of the casing portion;
a motor including
a rotor core including a permanent magnet and attached to the rotary shaft,
a stator core including a plurality of coils, and
a can that houses the rotor core; and
a control unit including
a driving circuit that supplies the plurality of coils with a driving signal for rotating the motor on a basis of a pre-set induced voltage constant, and
a correcting circuit that corrects the induced voltage constant on a basis of an output of the first temperature sensor.

2. The vacuum pump according to claim 1, wherein
the correcting circuit corrects the induced voltage constant such that an induced voltage of the motor becomes lower as the temperature of the casing portion becomes higher if the temperature of the casing portion is within a predetermined temperature range.

3. The vacuum pump according to claim 2, wherein
the correcting circuit corrects the induced voltage constant in accordance with a first approximate straight line having a first temperature gradient if the temperature of the casing portion is equal to or higher than a first temperature and is lower than a second temperature, and corrects the induced voltage constant in accordance with a second approximate straight line having a second temperature gradient different from the first temperature gradient if the temperature of the casing portion is equal to or higher than the second temperature and is lower than a third temperature.

4. The vacuum pump according to claim 3, wherein
the first temperature gradient is larger than the second temperature gradient.

5. The vacuum pump according to claim 1, wherein
the control unit further includes
a second temperature sensor that detects a temperature of the driving circuit, and
the driving circuit stops supply of the driving signal into the plurality of coils if the temperature of the driving circuit is equal to or higher than the third temperature.

6. A control method for a vacuum pump including a permanent magnet synchronous motor, comprising:
generating a driving signal for rotating the motor on a basis of a pre-set induced voltage constant; and
correcting the induced voltage constant on a basis of an output of a temperature sensor attached to a metal casing portion that constitutes a part of a pump main body.

7. The control method for a vacuum pump according to claim 6, further comprising
correcting the induced voltage constant such that an induced voltage of the motor becomes lower as the temperature of the casing portion becomes higher if the temperature of the casing portion is within a predetermined temperature range.

8. The control method for a vacuum pump according to claim 7, further comprising
correcting the induced voltage constant in accordance with a first approximate straight line having a first temperature gradient if the temperature of the casing portion is equal to or higher than a first temperature and is lower than a second temperature; and
correcting the induced voltage constant in accordance with a second approximate straight line having a second temperature gradient different from the first temperature gradient if the temperature of the casing portion is equal to or higher than the second temperature and is lower than a third temperature.

9. The vacuum pump according to claim 2, wherein
the control unit further includes
a second temperature sensor that detects a temperature of the driving circuit, and
the driving circuit stops supply of the driving signal into the plurality of coils if the temperature of the driving circuit is equal to or higher than the third temperature.

10. The vacuum pump according to claim 3, wherein
the control unit further includes
a second temperature sensor that detects a temperature of the driving circuit, and
the driving circuit stops supply of the driving signal into the plurality of coils if the temperature of the driving circuit is equal to or higher than the third temperature.

11. The vacuum pump according to claim 4, wherein
the control unit further includes
a second temperature sensor that detects a temperature of the driving circuit, and
the driving circuit stops supply of the driving signal into the plurality of coils if the temperature of the driving circuit is equal to or higher than the third temperature.
